(19) United States
(12) Patent Application Publication
(10) Pub. No.: US 2011/0063336 A1
(43) Pub. Date: Mar. 17, 2011

(54) SINGLE-CELL GAP TYPE TRANSFLECTIVE LIQUID CRYSTAL DISPLAY AND DRIVING METHOD THEREOF

(75) Inventors: PO-SHENG SHIH, Miao-Li County (TW); JIA-SHYONG CHENG, Miao-Li County (TW); PO-YANG CHEN, Miao-Li County (TW); JIUNN-SHYONG LIN, Miao-Li County (TW)

(73) Assignee: CHIMEI INNOLUX CORPORATION, Miao-Li County (TW)

(21) Appl. No.: 12/875,150

(22) Filed: Sep. 3, 2010

(30) Foreign Application Priority Data
Sep. 17, 2009 (CN) 200910307220.8

(51) Int. Cl. G09G 5/10; G09G 5/00; H01J 9/00

(52) U.S. Cl. 345/690; 345/211; 445/24

(57) ABSTRACT

A single-cell gap type transflective liquid crystal display and a driving method thereof are provided. A multiplexer is added to each pixel of a thin-film transistor substrate of the display to respectively control voltages of a transmissive region and a reflective region of each pixel in conjunction with a modulation scan signal and different voltage data signals. Thus, a VT curve of the transmissive region and a VR curve of the reflective region can be adjusted to be identical.

### BACKGROUND OF THE DISCLOSURE

1. Field of the Disclosure

The disclosure relates in general to a transflective liquid crystal display, and more particularly to a single-cell gap type transflective liquid crystal display having a reflective region and a transmissive region, both of which have the identical transmittance, and a driving method thereof.

2. Description of Related Art

In order to satisfy the application environments of electronic products, liquid crystal displays may be classified into a transmissive type, a reflective type and a transflective type according to different optical environments, wherein the transflective liquid crystal display adopts a backlight module, but a portion of the display light source relies on the external environment light. For the electronic products (e.g., mobile phones, digital cameras and the like), which need the advanced mobile displays, they are frequently used outdoors. So, most of the electronic products adopt the transflective liquid crystal display as the preferred solution of the electronic products which need the advanced mobile displays.

The driving principle and the technology developing procedure of the transflective liquid crystal display will be described in the following.

Referring to FIG. 1, the early transflective liquid crystal display 10 includes a substrate (also referred to as a top substrate) 11, a thin-film transistor substrate (also referred to as a bottom substrate) 12, and a liquid crystal layer 13 interposed between the substrates 11 and 12. The bottom substrate 12 is defined with a plurality of pixels (pixel areas) arranged in a matrix, and each pixel (pixel area) includes a transmissive region 121 and a reflective region 122. The reflective region 122 is formed with a reflective layer 123 on the bottom substrate 12, so the external light penetrates through the top substrate 11 and enters the reflective layer 123, and is then reflected by the reflective layer 123 and penetrates through the top substrate 11. Because the liquid crystal layer 13 is interposed between the top substrate 11 and the bottom substrate 12, the reflected external light may serve as the display light source. The backlight light source in back of the bottom substrate 12 directly penetrates through the transmissive region 121, the liquid crystal layer 13 and the top substrate 11 and then travels out. Thus, the so-called transflective liquid crystal display 10 effectively adopts the backlight light source and the external light source as the display light source.

Compared with the transmissive liquid crystal display, the high power backlight light source is not used. The power may be saved, and the size of the overall electronic product can be reduced.

However, the transflective liquid crystal display 10 has the poor display quality caused by the addition of the reflective layer and the gray level inversion phenomenon. For the single pixel, the external light enters the reflective region and is then reflected to the top substrate 11. So, its optical path difference is twice as long as that of the backlight light source, and the gray level inversion phenomenon is caused. Therefore, as shown in FIG. 2, in order to make the transmissive region 121 and the reflective region 122 have the identical optical path differences, the currently available product has adopted the transflective liquid crystal display 10a with the so-called dual-cell gap pixels, which is characterized in that an overcoat layer 124 is downwardly formed at a position of the top substrate corresponding to the reflective region 122, so that the cell gap D2 of the reflective region 122 is about one half of the cell gap D1 of the transmissive region. Consequently, the optical path differences of the transmissive region 121 and the reflective region 122 may be adjusted to be substantially identical. As shown in FIG. 3, the result of the voltage-to-reflectivity (hereinafter referred to as VR) curve is simulated in the reflective region according to four different cell gaps (4.0 um/2.2 um/2.0 um/1.8 um). As shown in the drawing, it is obtained that, compared with the voltage-to-transmittance (hereinafter referred to as VT) curve of the transmissive region with the cell gap of 4.0 um, the VR curve corresponding to the same cell gap of 4.0 um is significantly different from the VT curve of the transmissive region due to the doubled optical path difference. However, for the cell gap D2 (2.0 um) of the reflective region, which is only one half of the cell gap D1 (4.0 um) of the transmissive region, the VR curve is closer to the VT curve of the transmissive region. Thus, the dual-cell gap pixel architecture can indeed make the optical path of the backlight approach the optical path of the reflected light so as to improve the drawback of the gray level inversion. However, this dual-cell gap architecture also has some other drawbacks, such as the complicated manufacturing processes, the low yield and that the edge of the overcoat layer 124 tends to have the liquid crystal light-leakage phenomenon. Thus, the display quality of the transflective liquid crystal display still cannot be effectively enhanced.

In view of the problems induced by the dual-cell gap pixel architecture, each panel factory again returns to the design of the single-cell gap pixel architecture in conjunction with another technique for decreasing the voltage of the reflective region to adjust the VR curve of the reflective region and the VT curve of the transmissive region to be identical so as to solve the problem of gray level inversion.

In summary, the transflective liquid crystal display of the currently adopted single-cell gap pixel structure still needs a better technological solution for overcoming the problem of gray level inversion.

### SUMMARY OF THE DISCLOSURE

According to the first disclosure, a driving method of a transflective liquid crystal display is provided. A multiplexer is added to each pixel of a thin-film transistor substrate. The voltages of a transmissive region and a reflective region of each pixel are controlled according to a modulation scan signal and different voltage data signals, so that a VT curve of the transmissive region and a VR curve of the reflective region can be adjusted to be identical.

The disclosure will become apparent from the following detailed description of the preferred but non-limiting embodiments. The following description is made with reference to the accompanying drawings.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 (Prior Art) is a longitudinal cross-sectional view showing one single pixel of a single-cell gap type transflective liquid crystal display.

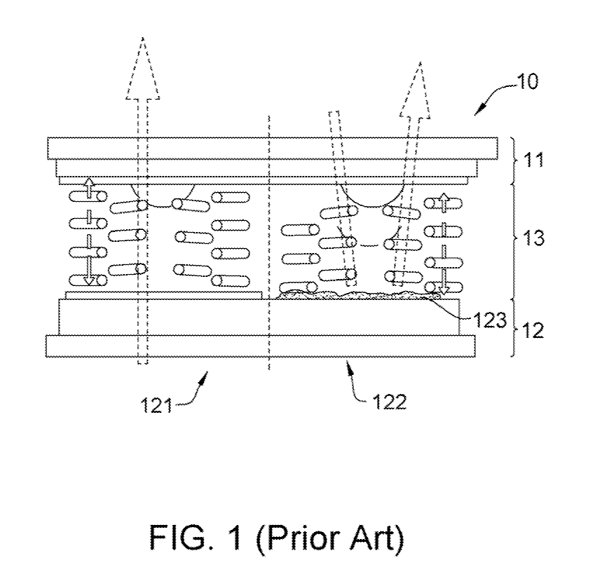

FIG. 2 (Prior Art) is a longitudinal cross-sectional view showing one single pixel of another dual-cell gap type transflective liquid crystal display.

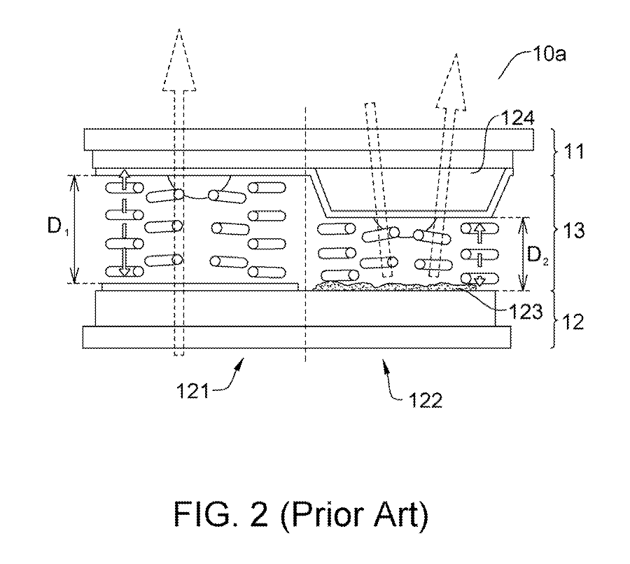

FIG. 3 (Prior Art) shows the VR curve and VT curve corresponding to different sizes of gaps simulated in FIG. 2.

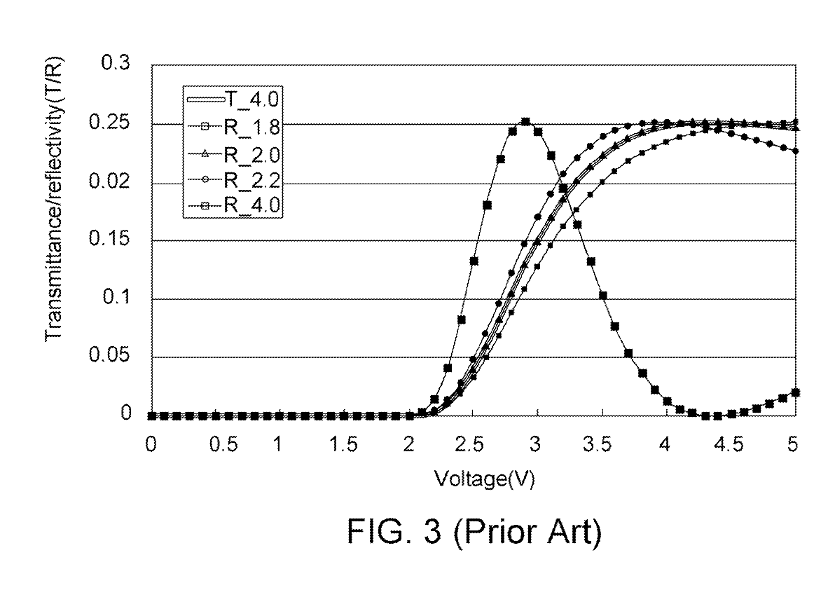

FIG. 4 is a schematic illustration showing the structure of a single-cell gap type transflective liquid crystal display according to a first embodiment of the disclosure.

FIG. 5 is an equivalent circuit diagram showing the single pixel of FIG. 4.

FIG. 6 shows waveforms of the modulation scan signal and the data signal of FIG. 4.

FIG. 7 is a schematic illustration showing another structure of the single-cell gap type transflective liquid crystal display of the disclosure.

FIG. 8 shows the waveforms of the first and second timing signals and the odd/even numbered scan signals of FIG. 7.

FIG. 9 shows the waveforms of another modulation scan signal and the data signal of FIG. 4.

FIG. 10 shows the graph of the voltage and the gray level of the transmissive region and the reflective region when FIG. 1 is simulated without adding the compensation technology.

FIG. 11 shows the graph of the voltage and the gray level of the transmissive region and the reflective region simulated in FIG. 4.

FIG. 12 is an equivalent circuit diagram showing one single pixel of the single-cell gap type transflective liquid crystal display according to a second embodiment of the disclosure.

FIG. 13 shows the waveforms of the modulation scan signal and the data signal of FIG. 12.

FIG. 14 shows the waveforms of another modulation scan signal and the data signal of FIG. 12.

FIG. 15 is a schematic illustration showing a layout pattern for implementing the scan lines G1 to GN and the sub-scan lines G1′ to GN′ of the thin-film transistor substrate of FIG. 12.

### DESCRIPTION OF EMBODIMENTS

Reference will now be made to the drawings to describe various embodiments in detail.

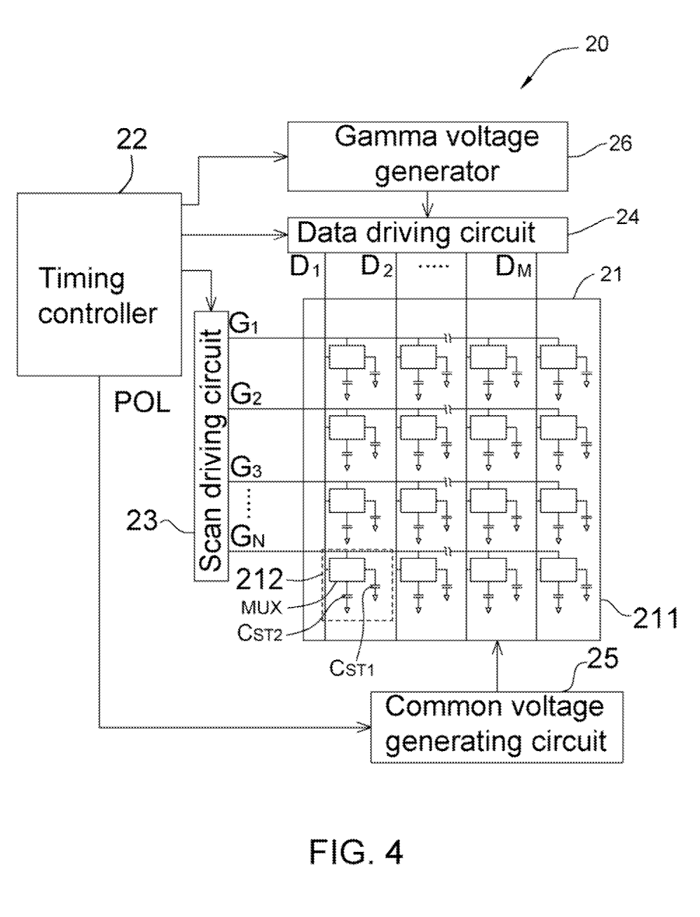

Referring to FIG. 4, a single-cell gap transflective liquid crystal display 20 of the disclosure includes a transflective liquid crystal panel 21, a timing controller 22, a scan driving circuit 23, a data driving circuit 24, a common voltage generating circuit 25 and a Gamma voltage generator 26.

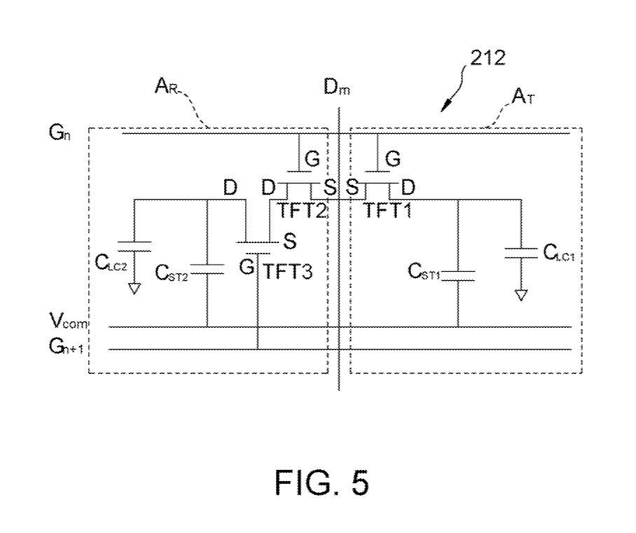

The transflective liquid crystal panel 21 includes a top substrate (not shown), a thin-film transistor substrate 211 and a liquid crystal layer (not shown) interposed between the top substrate and the thin-film transistor substrate 211. The thin-film transistor substrate 211 is formed with a common electrode (Vcom), scan lines G1 to GN and data lines D1 to DM intersecting with the scan lines G1 to GN, wherein a pixel 212 is defined at an intersection of the scan lines G1 to GN and the data lines D1 to DM. FIG. 5 is an equivalent circuit diagram showing the single pixel 212 of the thin-film transistor substrate 211 according to a first embodiment of the disclosure. Referring to FIG. 5, the pixel 212 includes a transmissive region AT, a reflective region AR and a multiplexer. The scan lines G1 to GN and the data lines D1 to DM of the thin-film transistor substrate 211 are respectively connected to the scan driving circuit 23 and the data driving circuit 24. The scan driving circuit 23 periodically and successively outputs the modulation scan signal to the scan lines G1 to GN, and the data driving circuit 24 respectively outputs two different voltage data signals to the data line Dm (m ranges from 1 to M) corresponding to each pixel 212 according to the gray level to be displayed by each pixel 212. Also, the common electrode (Vcom) is connected to the common voltage generating circuit 25 to provide the same low voltage level to each pixel 212.

In this embodiment, the multiplexer of each pixel includes a thin-film transistor TFT1 of the transmissive region A_{T}, a thin-film transistor TFT2 and a thin-film transistor TFT3 of the reflective region A_{R}. The first thin-film transistor TFT1, formed in the transmissive region A_{T}, has a drain D connected to a storage capacitor C_{ST1} formed in the transmissive region A_{T} and a liquid crystal capacitor C_{LC1} formed in the transmissive region A_{T}, a gate G connected to the scan line Gₙ (n ranges from 1 to N) of the first pixel of the thin-film transistor substrate 211, and a source S connected to the data line Dₘ of the first pixel of the thin-film transistor substrate 211.

The thin-film transistor TFT2, formed in the reflective region A_{R}, has a source S connected to the data line Dₘ of the first pixel of the thin-film transistor substrate 211, and a gate G connected to the scan line Gₙ of the first pixel.

The thin-film transistor TFT3, formed in the reflective region A_{R}, has a source S connected to the drain D of the thin-film transistor TFT2, a gate G connected to a scan line G_{n 1} of the second pixel of the pixels next to the first pixel, and a drain D connected to a storage capacitor C_{ST2} formed in the reflective region A_{R} and a liquid crystal capacitor C_{LC2} formed in the reflective region A_{R}.

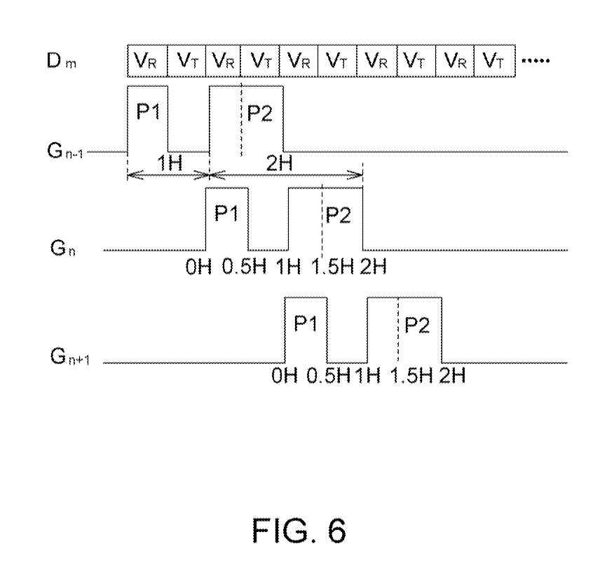

FIG. 6 shows the waveforms of the modulation scan signal and the data signal used in this embodiment. Because the gates G of the thin-film transistors TFT2 and TFT3 of the reflective region are respectively connected to the scan line Gₙ of the first pixel and the scan line Gₙ₊₁ of the second pixel, the waveform diagrams show the waveforms of a scan line Gₙ₋₁ of one pixel previous to the first pixel, the scan line Gₙ of first pixel and the scan line Gₙ₊₁ of the second pixel. According to the waveform diagrams, it is obtained that the pulse length of the scan signal outputted from the scan driving circuit 23 to each of the scan lines G₁ to G_{N} totally occupies 2 H time, wherein the first high potential signal P1 occupies 0 H to 0.5 H, the second high potential signal P2 occupies 1 H to 2 H, and the scan signals of the previous and next scan lines Gₙ and Gₙ₊₁ are held by the time difference of 1 H. Thus, the gates G of the thin-film transistors TFT2 and TFT3 of the reflective region of the first pixel turn on when the scan signal Gₙ of the first pixel is at the second high potential P2 between 1 H and 1.5 H and turn on when the next scan signal is at the first high potential P1 between 0H to 0.5 H, so as to write the voltage data signal V_{R}, which is inputted to the data line of the first pixel in the 0.5 H time difference, into the storage capacitor C_{ST2} of the reflective region. Furthermore, the gate G of the thin-film transistor TFT1 of the transmissive region is also connected to the scan line Gₙ of the first pixel, the thin-film transistor TFT1 of the transmissive region is in a turned on state. So, the voltage data signal V_{R} corresponding to the reflective region is also written into the storage capacitor C_{ST2} from 1 H to 1.5 H of the scan signal Gₙ, and the voltage data signal V_{T} corresponding to the transmissive region is written into the storage capacitor C_{ST1} from 1.5 H to 2.0 H, so that the storage capacitors C_{ST1} and C_{ST2} store different voltages V_{R} and V_{T} for representing the same gray level. Thus, the VT curve of the transmissive region and the VR curve of the reflective region are adjusted to be identical.

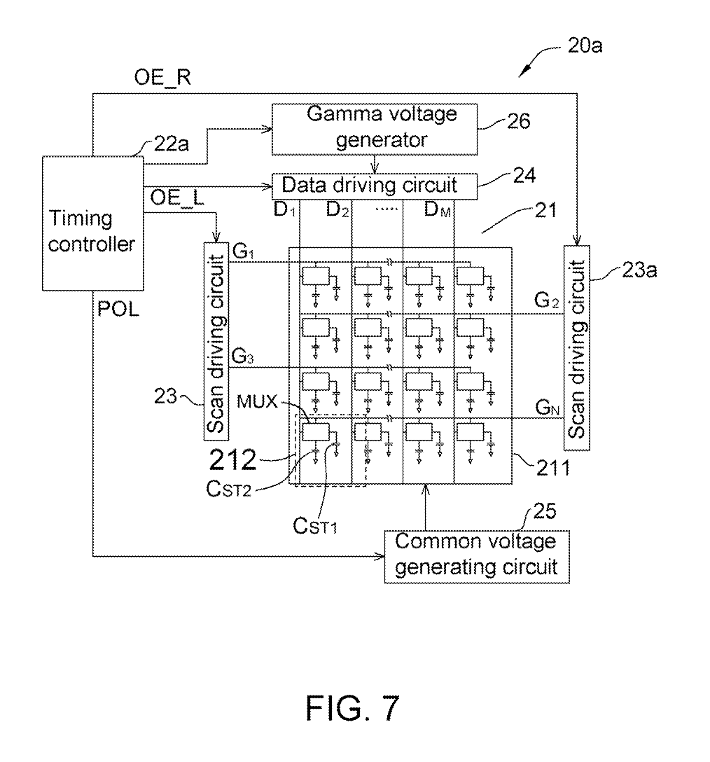

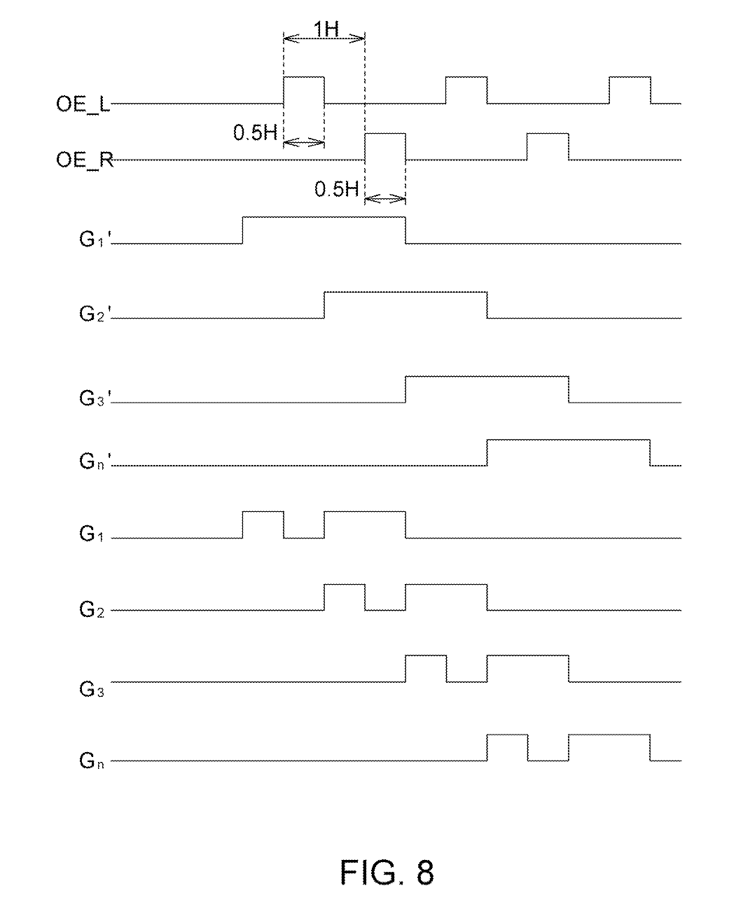

In the embodiment, the modulation scan signal may be obtained according to the following method. As shown in FIG. 7, the scan lines G₁ to G_{N} of the thin-film transistor substrate 211 are divided into the odd numbered scan lines G₁, G₃, . . . , and the even numbered scan lines G₂, G₄, . . . , Gₙ according to the position order, wherein the output ends of the odd numbered scan lines G₁, G₃, . . . are formed on the left side of the thin-film transistor substrate 211, while the output ends of the even numbered scan lines G₂, G₄, . . . , Gₙ are formed on the right side of the thin-film transistor substrate 211. Thus, a scan driving circuit 23a may further be added, and the two scan driving circuits 23 and 23a are respectively connected to the odd numbered scan lines G₁, G₃, . . . , and the even numbered scan lines G₂, G₄, . . . , Gₙ. In addition, as shown in FIG. 8, a timing controller 22a is provided to provide a first timing signal OE_L and a second timing signal OE_R, wherein the first timing signal OE_L and the second timing signal OE_R have the same frequency, the time difference of 1 H, and the pulse occupying 0.5 H. The first and second timing signals are respectively outputted to the two scan driving circuits 23 and 23a so that each of the scan driving circuits 23 and 23a adjusts the high potential scan signals G₁′, G₂′, G₃′, . . . , Gₙ′, which originally have high level in 1 H, with high level in 1 H, and the high potential scan signals G₁′, G₂′, G₃′, . . . , Gₙ′ are then respectively subtracted from the corresponding first and second timing signals OE_L and OE_R to obtain the modulation scan signals G₁, G₂, G₃, . . . ., Gₙ, as shown in FIG. 6.

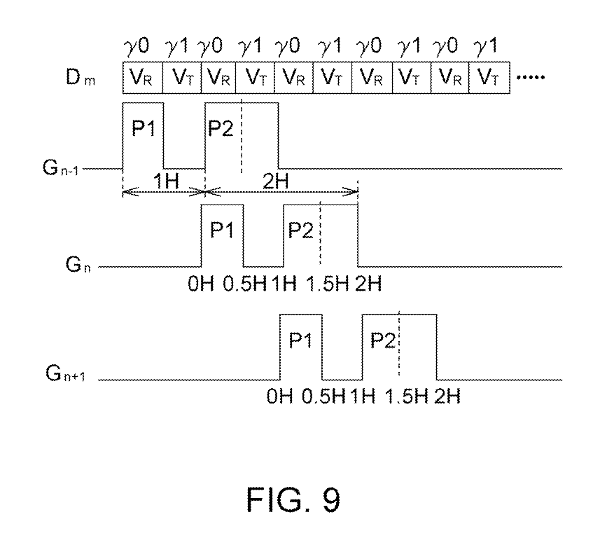

Furthermore, this embodiment has to provide the different voltage data signals V_{R} and V_{T} to the reflective region and the transmissive region, respectively. Thus, the operation frequency of the data driving circuit 24 is doubled so that two different voltage data signals V_{R} and V_{T} may be outputted to each data line Dₘ within the 1 H time. As shown in FIG. 9, because the design of the data driving circuit with the doubled frequency is more complicated, the method of providing different voltages to each data line when the same gray level is to be written into the reflective region and the transmissive region may be performed by directly adjusting the Gamma voltages γ0 and γ1 with different gray levels, which are provided from the Gamma voltage generator 26 to the data driving circuit 24. Thus, the data driving circuit 24 can output the corresponding voltage data signals to the reflective region and the transmissive region without increasing the operation frequency.

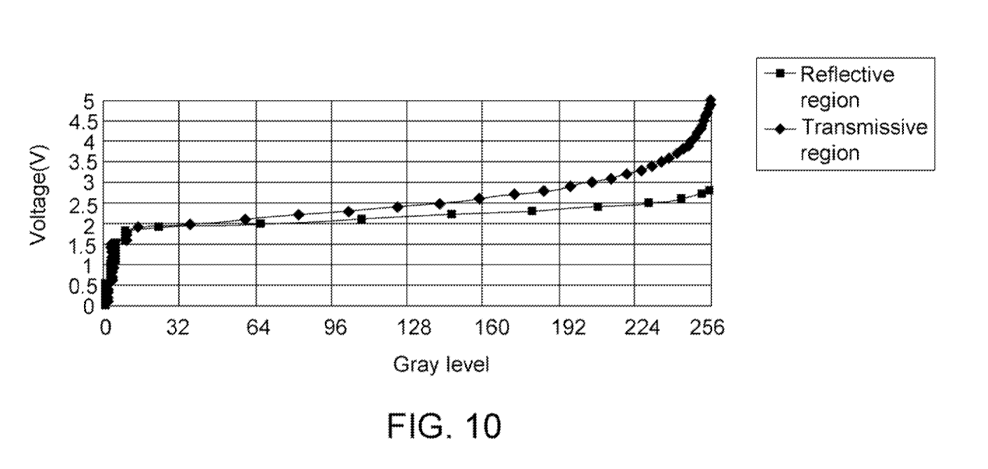

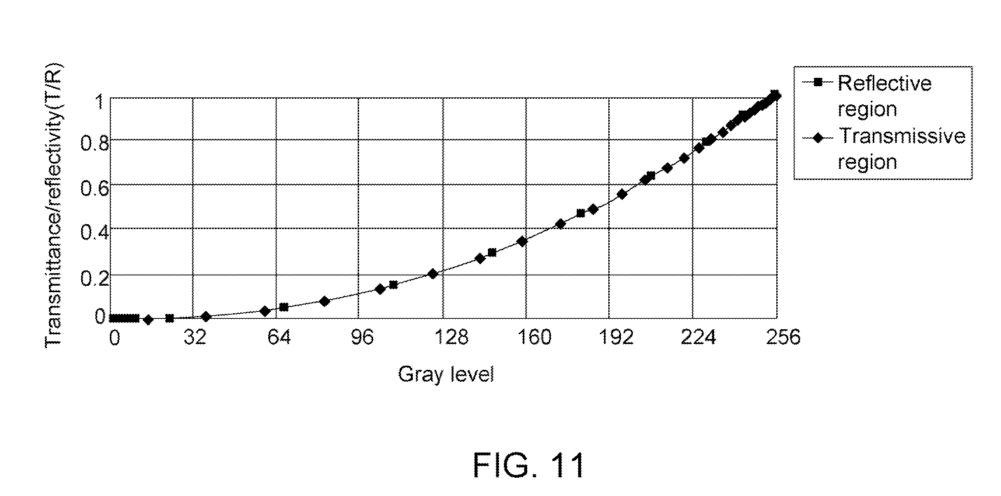

FIG. 10 shows the graph of the voltage and the gray level of the transmissive region and the reflective region when the single-cell gap type transflective liquid crystal display is simulated without adding the compensation technology. As shown in FIG. 10, it is obtained that different gray levels are represented if the same voltage is written into the transmissive region and the reflective region of the single pixel. Thus, the disclosure adjusts the same data line to write two different voltage data signals so that the transmissive region and the reflective region of the single pixel represent the same gray level according to the voltage difference of different gray levels of the transmissive region and the reflective region. As shown in FIG. 11, the VT curve and the VR curve may be completely identical when the transmissive region and the reflective region represent any gray level according to the driving method of the disclosure.

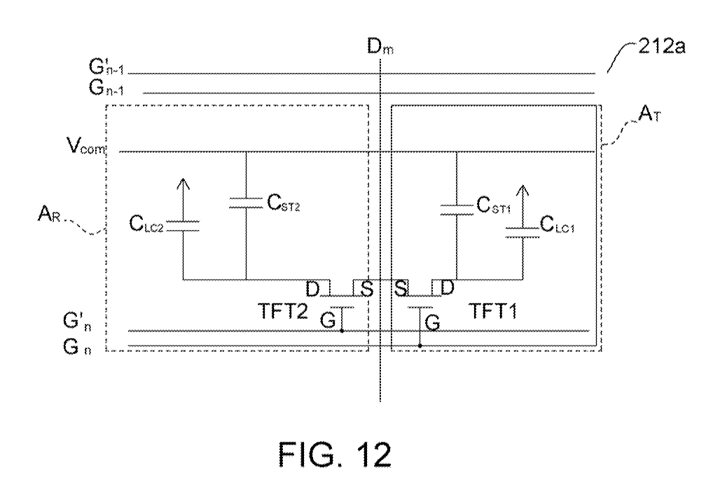

The thin-film transistor substrate according to the first embodiment of the disclosure has been described hereinabove, and a pixel 212a of a thin-film transistor substrate according to a second embodiment of the disclosure will be described with reference to FIG. 12.

The pixel 212a of the thin-film transistor substrate of this embodiment is almost the same as the structure of the first embodiment except that the scan lines G₁ to G_{N} of the thin-film transistor substrate are further formed with sub-scan lines G₁′ to G_{N}′ horizontally interlaced with the scan lines G₁ to G_{N}. So, each pixel 212a corresponds to one scan line Gₙ and one sub-scan line Gₙ′, wherein the scan lines G₁ to G_{N} and the sub-scan lines G₁′ to G_{N}′ are connected to the scan driving circuit (not shown). The multiplexer of the single pixel 212a according to this embodiment further includes a transmissive region thin-film transistor TFT1 and a reflective region thin-film transistor TFT2.

The thin-film transistor TFT1 is formed in the transmissive region A_{T} and connected to the scan line Gₙ, the data line Dₘ, the storage capacitor C_{ST1} and the liquid crystal capacitor C_{LC1}, driven by the modulation scan signal of the scan line Gₙ of the first pixel to turn on and off, and writes the voltage data signal of the data line Dₘ of the first pixel into the storage capacitor C_{ST1} when the thin-film transistor turns on.

The thin-film transistor TFT2 is formed in the reflective region A_{R} and connected to the sub-scan line Gₙ′, the data line Dₘ, the storage capacitor C_{ST2} and the liquid crystal capacitor C_{LC2}, driven by the modulation scan signal of the sub-scan line Gₙ′ of the first pixel to turn on and off, and writes the voltage data signal of the data line Dₘ of the first pixel into the storage capacitor C_{ST2} when the thin-film transistor turns on.

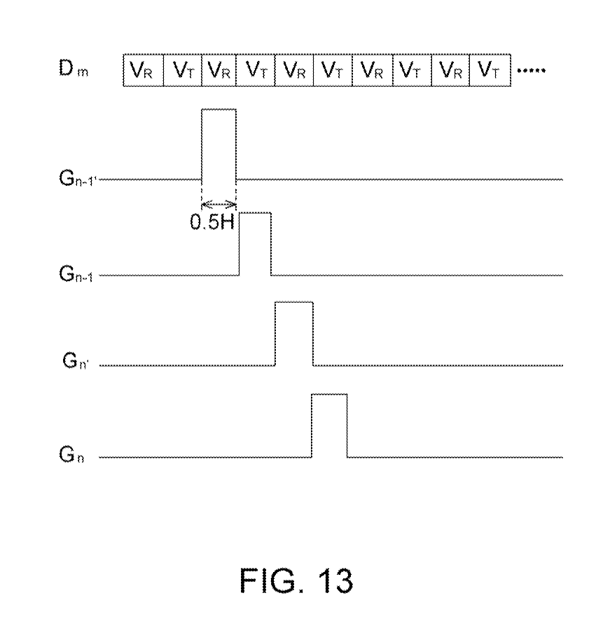

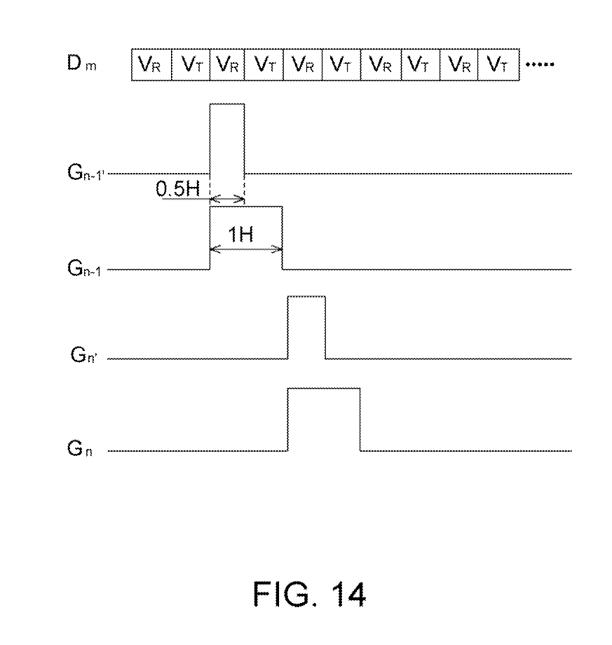

FIG. 13 shows the waveforms of the modulation scan signal and the data signal of FIG. 12. As shown in FIG. 13, the scan driving circuit (not shown) successively alternately outputs the modulation scan signal to the sub-scan line Gₙ′ and the scan line Gₙ of each pixel. Each sub-scan signal Gₙ′ and each scan signal Gₙ include 0.5 H high potential signal. The neighboring sub-scan signal Gₙ′ and scan signal Gₙ have the 0.5 H time difference. Thus, the total time of the high potential signal of the sub-scan signal Gₙ′ and the scan signal Gₙ of the same pixel is 1 H. Because the high potential signal of the sub-scan signal Gₙ′ of the single pixel is earlier than the scan signal Gₙ by the 0.5 H time, and the gate G of the thin-film transistor TFT2 is connected to the sub-scan line Gₙ′, the gate of the thin-film transistor TFT2 firstly turns on, and the voltage data signal V_{R} of the data line Dₘ of the first pixel is written into the storage capacitor C_{ST2} for the 0. 5H time. Therefore, the gate G1 of the thin-film transistor TFT1 is driven by the high potential signal of the scan line Gₙ, and the corresponding voltage data signal V_{T} on the data line Dₘ of the first pixel is written into the storage capacitor C_{ST1}. In addition, as shown in FIG. 14, the scan driving circuit may also continuously output the 1 H high potential signal to each scan line Gₙ, but still continuously outputs the 0.5 H high potential signal to each sub-scan line Gₙ′ to make the sub-scan signal Gₙ′ and the scan signal Gₙ of the single pixel have the overlap of 0.5 H.

According to the waveforms of FIGS. 13 and 14, different voltage data signals V_{T} and V_{R} have to be provided to the reflective region and the transmissive region. Thus, the operation frequency of the data driving circuit is doubled, and two different voltage data signals V_{T} and V_{R} are respectively outputted to each data line Dₘ within the 1 H time. In order to simplify the frequency-doubled data driving circuit, the Gamma voltages with different gray levels, which are provided from the Gamma voltage generator to the data driving circuit, may be directly adjusted, so the data driving circuit can respectively output the corresponding voltage data signals to the reflective region and the transmissive region without increasing the operation frequency of the data driving circuit.

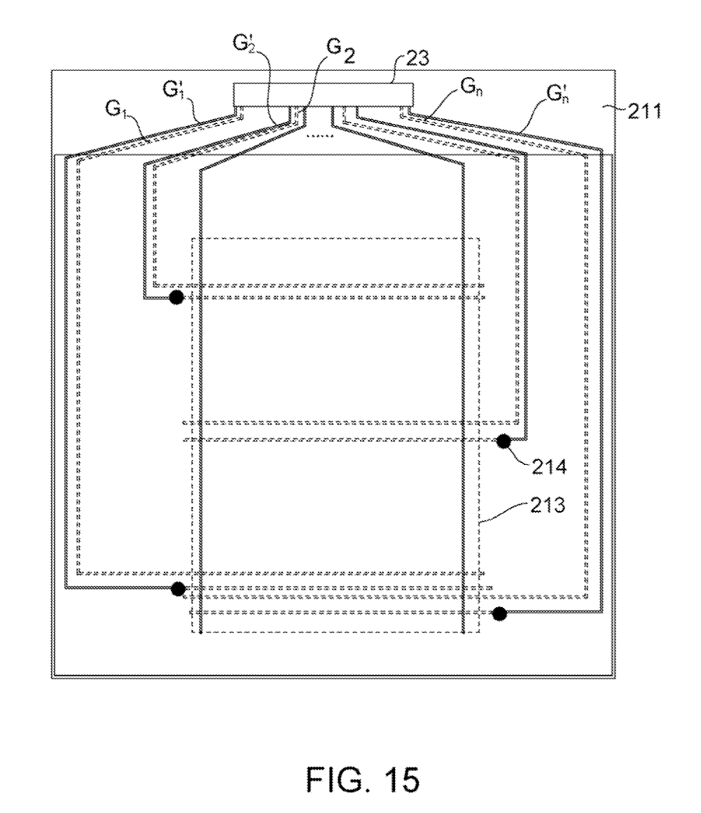

In the transflective liquid crystal display according to the second embodiment of the disclosure, the number of the thin-film transistor substrate scan lines is two times more than that of the thin-film transistor substrate scan lines of the first embodiment, and the problem of the insufficient peripheral circuit layout area of the thin-film transistor substrate directly appears. FIG. 15 is a schematic illustration showing a layout pattern for implementing the scan lines G₁ to G_{N} and the sub-scan lines G₁′ to G_{N}′ of the thin-film transistor substrate according to the second embodiment of the disclosure. In this embodiment, each of the line segments of the sub-scan lines G₁′ to G_{N}′ and each of the line segments of the scan lines G₁ to G_{N} corresponding to the display region 213 of the thin-film transistor substrate 211 are formed by a first metal manufacturing process, while each of the line segments of the sub-scan lines G₁′ to G_{N}′ and each of the line segments of the scan lines G₁ to G_{N} disposed outside the display region 213 of the thin-film transistor substrate 211 are alternately formed by a second metal manufacturing process. For example, each of the line segments of the scan lines G₁ to G_{N} within the display region 213 of the thin-film transistor substrate is stilled formed by the first metal manufacturing process, while each of the line segments of the sub-scan lines G₁′ to G_{N}′ disposed outside the display region 213 of the thin-film transistor substrate is still formed by the second metal manufacturing process. A via 214 is provided at the intersection between the line segments of each of the sub-scan lines G₁′ to G_{N}′ formed in the first and second metal manufacturing processes to electrically connect the line segments of the sub-scan lines together. Because the line segments formed in the first and second metal manufacturing processes are isolated by an insulating layer, the transversal gaps between the line segments of each of the sub-scan lines G₁′ to G_{N}′ and the line segments of each of the scan lines G₁ to G_{N} disposed outside the display region 213 of the thin-film transistor substrate may be shortened, so that the interconnection density is increased in the limited area. Although each of the scan lines G₁ to G_{N} and each of the sub-scan lines G₁′ to G_{N}′ are formed by the first and second metal manufacturing processes, the RC delay times caused thereby are not the same. However, the voltages of the transmissive region and the reflective region of the disclosure are originally different from each other and the conditions viewed by the pixels are the same. So, the problem of the non-uniform display frame (mura) cannot be caused due to the RC delay time.

In summary, the transflective liquid crystal display driving method of the disclosure is to add a multiplexer to each pixel of its thin-film transistor substrate, and to respectively control the voltages of the transmissive region and the reflective region of each pixel according to the modulation scan signal and the different voltage data signals so as to adjust the VT curve of the transmissive region and the VR curve of the reflective region to be identical. In addition, the disclosure adopts this driving circuit, and the transflective liquid crystal display has the advantages of the low cost, the high yield, the elimination of the retained image and the elimination of the horizontal cross-talk.

While the disclosure has been described by way of examples and in terms of preferred embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

It is to be understood that even though numerous characteristics and advantages of the present embodiments have been set forth in the foregoing description, together with details of the structures and functions of the embodiments, the disclosure is illustrative only; and that changes may be made in detail, especially in matters of shape, size, and arrangement of parts, within the principles of the embodiments, to the full extent indicated by the broad general meaning of the terms in which the appended claims are expressed.

What is claimed is:

1. A driving method of a single-cell gap type transflective liquid crystal display, wherein the transflective liquid crystal display comprises a thin-film transistor substrate, on which a plurality of pixels arranged in a matrix is defined, each of the pixels comprises a reflective region and a transmissive region, characterized in that:
the driving method is to add a multiplexer to each of the pixels of the thin-film transistor substrate, the multiplexer is connected to a first storage capacitor formed in the transmissive region and a second storage capacitor formed in the reflective region, the multiplexer respectively writes different voltage data signals into the first storage capacitor and the second storage capacitor of each of the pixels based on a plurality of modulation scan signals and the different voltage data signals so as to adjust a VT curve of the transmissive region and a VR curve of the reflective region to be identical.

2. The method according to claim 1, wherein each of the multiplexers comprises:
a first thin-film transistor, formed in the transmissive region and connected to a scan line of a first pixel of the pixels, a data line of the first pixel and the first storage capacitor, wherein the first thin-film transistor is driven by the modulation scan signal of the scan line of the first pixel to turn on and off, and writes the voltage data signal of the data line of the first pixel into the first storage capacitor when the first thin-film transistor turns on;
a second thin-film transistor, formed in the reflective region and connected to the scan line of the first pixel and the data line of the first pixel, wherein the second thin-film transistor is driven by the modulation scan signal of the scan line of the first pixel to turn on and off; and
a third thin-film transistor, formed in the reflective region, serially connected to the second thin-film transistor, and connected to a scan line of a second pixel of the pixels next to the first pixel and the second storage capacitor, wherein the third thin-film transistor is driven by the modulation scan signal of the scan line of the second pixel to turn on and off, and writes the voltage data signal of the data line of the first pixel into the first storage capacitor through the second thin-film transistor when the third thin-film transistor and the second thin-film transistor simultaneously turn on.

3. The method according to claim 2, wherein the scan lines of the thin-film transistor substrate successively periodically receive one of the modulation scan signals, each of the modulation scan signals is a 2 H driving signal comprising a 0.5 H first high potential signal, a 0.5 H low potential signal and a 1 H second high potential signal, and a time difference of the modulation scan signals between neighboring two of the scan lines is about 1 H.

4. The method according to claim 3, wherein each of the modulation scan signals is generated by taking two timing signals with the time difference of 1 H and a pulse time occupying 0.5 H, and then subtracting odd numbered and even numbered scan signals containing the 2 H high potential signal from the two timing signals respectively.

5. The method according to claim 1, further comprising forming a plurality of scan lines and a plurality of sub-scan lines horizontally interlaced with the scan lines on the thin-film transistor substrate to intersect with a plurality of data lines, wherein each of the pixels corresponds to one of the scan lines and one of the sub-scan lines, and each of the multiplexers comprises:
a first thin-film transistor, formed in the transmissive region and connected to the scan line of a first pixel of the pixels, the data line of the first pixel and the first storage capacitor, wherein the first thin-film transistor is driven by the modulation scan signals of the scan line of the first pixel to turn on and off, and writes the voltage data signals of the data line of the first pixel into the first storage capacitor when the first thin-film transistor turns on; and
a second thin-film transistor, formed in the reflective region and connected to the sub-scan line of the first pixel, the data line of the first pixel and the first storage capacitor, wherein the second thin-film transistor is driven by the modulation scan signals of the sub-scan line of the first pixel to turn on and off, and writes the voltage data signals of the data line of the first pixel into the first storage capacitor when the second thin-film transistor turns on.

6. The method according to claim 5, wherein the sub-scan lines and the scan lines of the thin-film transistor substrate successively periodically receive one of the modulation scan signals, each of the modulation scan signals is a 0.5 H driving signal, and a time difference of the modulation scan signals between the sub-scan line and the scan line corresponding to each of the pixels is about 0.5 H.

7. The method according to claim 5, wherein the sub-scan lines of the thin-film transistor substrate successively periodically receive a first modulation scan signal, the scan lines of the thin-film transistor substrate successively periodically receive a second modulation signal, and the first modulation signal is a 0.5 H high potential signal, the second modulation signal is a 1 H high potential signal, and no time difference of the modulation scan signals exists between the sub-scan line and the scan line corresponding to each of the pixels.

8. The method according to claim 1, wherein the transflective liquid crystal display further comprises a data driving circuit and a Gamma voltage generator connected to the data driving circuit, wherein the data driving circuit provides the voltage data signal of each of the pixel data lines, and the data driving circuit respectively outputs the corresponding voltage data signals to the reflective region and the transmissive region by directly adjusting Gamma voltages with different gray levels provided from the Gamma voltage generator to the data driving circuit.

9. A single-cell gap type transflective liquid crystal display, comprising a transflective liquid crystal panel, a timing controller, a scan driving circuit and a data driving circuit, characterized in that:
the transflective liquid crystal panel comprises a top substrate, a thin-film transistor substrate and a liquid crystal layer disposed between the top substrate and the thin-film transistor substrate, the thin-film transistor substrate is formed with a common electrode, scan lines and data lines intersecting with the scan lines, a pixel is defined at an intersection between the scan line and the data line, each of the pixels comprises a transmissive region, a reflective region and a multiplexer, and the multiplexer is connected to the scan line of a first pixel of the pixels and the data line of the first pixel;
the scan driving circuit is connected to the scan lines to periodically successively output a plurality of modulation scan signals to the scan lines to drive the multiplexer of each of the pixels and to determine an on/off order and an turn-on time of each of the reflective region and the transmissive region;
the data driving circuit is connected to the data lines and outputs two voltage data signals with different voltages to the transmissive region and the reflective region of each of the pixels, which are turned on according to the same gray level; and
the timing controller provides a constant timing signal to the scan driving circuit and the data driving circuit.

10. The display according to claim 9, wherein each of the multiplexers comprises:
a first thin-film transistor, formed in the transmissive region and connected to the scan line of the first pixel, the data line of the first pixel and a first storage capacitor, wherein the first thin-film transistor is driven by the modulation scan signal of the scan line of the first pixel to turn on and off, and writes the voltage data signal of the data line of the first pixel into the first storage capacitor when the first thin-film transistor turns on;
a second thin-film transistor, formed in the reflective region and connected to the scan line of the first pixel and the data line of the first pixel, wherein the second thin-film transistor is driven by the modulation scan signal of the scan line of the first pixel to turn on and off; and
a third thin-film transistor, formed in the reflective region, serially connected to the second thin-film transistor, and connected to the scan line of a second pixel of the pixels next to the first pixel and a second storage capacitor, wherein the third thin-film transistor is driven by the modulation scan signal of the scan line of the second pixel to turn on and off, and writes the voltage data signal of the data line of the first pixel into the first storage capacitor through the second thin-film transistor when the third thin-film transistor and the second thin-film transistor simultaneously turn on.

11. The display according to claim 10, wherein the scan lines of the thin-film transistor substrate successively periodically receive one of the modulation scan signals, each of the modulation scan signal is a 2 H driving signal comprising a 0.5 H first high potential signal, a 0.5 H low potential signal and a 1 H second high potential signal, and a time difference of the modulation scan signals between neighboring two of the scan lines is about 1 H.

12. The display according to claim 11, wherein:
the scan lines comprises odd numbered scan lines and even numbered scan lines formed on two opposite sides of the thin-film transistor substrate;
the timing controller provides a first timing signal and a second timing signal, and the first timing signal and the second timing signal have the same frequency and the time difference of 1 H, wherein a pulse occupies 0.5 H; and
the scan driving circuit successively generates odd numbered and even numbered scan signals comprising a 2 H high potential signal, and respectively subtracts the odd numbered and even numbered scan signals from the first and second timing signals to output the modulation scan signals.

13. The display according to claim 9, further comprising forming a plurality of scan lines and a plurality of sub-scan lines horizontally interlaced with the scan lines on the thin-film transistor substrate to interest with a plurality of data lines, wherein each of the pixels corresponds to one of the scan lines and one of the sub-scan lines, and each of the multiplexers comprises:
a first thin-film transistor, formed in the transmissive region and connected to the scan line of the first pixel, the data line of the first pixel and the first storage capacitor, wherein the first thin-film transistor is driven by the modulation scan signals of the scan line of the first pixel to turn on and off, and writes the voltage data signals of the data line of the first pixel into the first storage capacitor when the first thin-film transistor turns on; and
a second thin-film transistor, formed in the reflective region and connected to the sub-scan line of the first pixel, the data line of the first pixel and the first storage capacitor, wherein the second thin-film transistor is driven by the modulation scan signals of the sub-scan line of the first pixel to turn on and off, and writes the voltage data signals of the data line of the first pixel into the first storage capacitor when the second thin-film transistor turns on.

14. The display according to claim 13, wherein the sub-scan lines and the scan lines of the thin-film transistor substrate successively periodically receive one of the modulation scan signals, each of the modulation scan signals is a 0.5 H driving signal, and a time difference of the modulation scan signals between the sub-scan line and the scan line corresponding to each of the pixels is about 0.5 H.

15. The display according to claim 13, wherein the sub-scan lines of the thin-film transistor substrate successively periodically receive a first modulation scan signal, the scan lines of the thin-film transistor substrate successively periodically receive a second modulation signal, and the first modulation signal is a 0.5 H high potential signal, the second modulation signal is a 1 H high potential signal, and no time difference of the modulation scan signals exists between the sub-scan line and the scan line corresponding to each of the pixel.

16. The display according to claim 9, further comprising:
a Gamma voltage generator, connected to the data driving circuit and providing Gamma voltages with different gray levels to the data driving circuit so that the data driving circuit respectively outputs corresponding voltage data signals to the reflective region and the transmissive region; and
a common voltage generating circuit, connected to the common electrode for providing a same low voltage level to each of the pixels.

17. A method of manufacturing the sub-scan lines and the scan lines in the single-cell gap type transflective liquid crystal display according to claim 13, wherein each of line segments of the sub-scan lines and each of line segments of the scan lines corresponding to a display region of the thin-film transistor substrate of the transflective liquid crystal display are formed by a first metal manufacturing process, each of line segments of the sub-scan lines and each of line segments of the scan lines disposed outside the display region of the thin-film transistor substrate are formed by a second metal manufacturing process, and a via is provided to electrically connect the scan lines formed in the first and second metal manufacturing processes.

18. The method according to claim 17, wherein each of the line segments of the sub-scan lines disposed outside the display region of the thin-film transistor substrate is formed by the second metal manufacturing process, and each of the line segments of the scan lines disposed inside the display region of the thin-film transistor substrate is formed by the first metal manufacturing process, wherein a via is provided to electrically connect the sub-scan lines disposed inside and outside the display region of the thin-film transistor substrate.
